(19) United States
(12) Patent Application Publication
(10) Pub. No.: US 2024/0386267 A1
(43) Pub. Date: Nov. 21, 2024

(54) INTERLEAVED TRANSFORMERS

(71) Applicant: Google LLC, Mountain View, CA (US)

(72) Inventor: Ting Chen, Mountain View, CA (US)

(21) Appl. No.: 18/668,073

(22) Filed: May 17, 2024

Related U.S. Application Data
(60) Provisional application No. 63/467,292, filed on May 17, 2023.

(51) Int. Cl. G06N 3/08; G06N 3/045

(52) U.S. Cl. CPC G06N 3/08; G06N 3/045

(57) ABSTRACT

Methods, systems, and apparatus, including computer programs encoded on computer storage media, for processing data using machine learning models. One of the methods includes obtaining a network input for the time step, wherein the network input comprises a plurality of data tokens; generating, from at least the network input for the time step, a plurality of groups of data tokens; initializing a plurality of sets of latent tokens for the time step, each set corresponding to a respective one of the plurality of groups; processing the data tokens in each group and the plurality of sets of latent tokens through each neural network block in a sequence of neural network blocks; and after processing each group of data tokens and the latent tokens through the sequence of neural network blocks, generating a network output for the time step.

### CROSS-REFERENCE TO RELATED APPLICATION

This application claims priority to U.S. Provisional Application No. 63/467,292, filed on May 17, 2023. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that generates a respective network output at each time step of a sequence of one or more time steps.

In particular, at each time step, the system obtains a network input for the time step and generates a network output for the time step.

The network input at each time step includes data tokens representing a collection of data elements, e.g., a sequence of data elements, an unordered set of data elements, a two-dimensional array of data elements, or a higher-dimensional array of data elements.

The network output at each time step is also a collection of data elements and can have the same format as the collection of data elements represented by the network input or a different format.

The subject matter described in this specification can be implemented in particular embodiments so as to realize one or more of the following advantages.

This specification describes a neural network architecture (the Far-reaching Interleaved Transformers (“FIT”)) that allocates computation adaptively to the input according to the distribution of information, allowing the system to scale to tasks that require generating or otherwise operating on high-dimensional data. The FIT architecture includes a sequence of multiple FIT blocks, also referred to as neural network blocks. The system partitions the input into groups of data tokens and initializes sets of latent tokens, which are decoupled from inputs and can exchange information globally. Stacking multiple blocks enables effective routing across local and global levels.

The system described in this specification provides for improved attention efficiency and reduced complexity. Some conventional techniques for addressing the complexity of full attention are not accelerator-friendly, or are not easily scalable.

The system described in this specification uses adaptive latent tokens designed for global attention, allowing for flexible and efficient information exchange across groups of data tokens. The system divides data tokens into groups, or a shorter sequence of tokens, and introduces latent tokens for every group of data tokens. The system interleaves multiple layers of parallel local attention on data tokens within each group, and global attention on a set of latent tokens from all groups. The system can use cross-attention to route information between data tokens and latent tokens, for example. Interleaving layers of local attention and global attention ensures the system is expressive and scalable.

Within each group, the system can use a high-bandwidth channel via full attention to attend to the information within each group. Globally, across groups, the system can use a lower-bandwidth channel, with compression, for example. Thus the system coordinates local processing and global processing efficiently. In a single forward pass, the system iteratively updates data tokens and latent tokens, ensuring that local information and global information have sufficient opportunities to integrate. Furthermore, the local attention within each group can be performed in parallel for all groups, e.g., by assigning each group to a respective set of one or more hardware accelerators. Each neural network can be composed of accelerator friendly attention blocks, making the system easy to deploy on hardware accelerators. Thus the system is more suitable for deployment on modern parallel computing hardware such as hardware accelerators, and optimizes performance of the hardware accelerators. Hardware accelerators perform matrix multiplications using dedicated circuitries, e.g., ASICs, FPGAS, graphic processing units (GPUs), or tensor processing units (TPUs), and more particularly on distributed machine learning systems comprising multiple TPUs and/or GPUs.

The system also provides for improved adaptive computation. For example, the system introduces a smaller number of latent tokens for every group of data tokens. Latents can have a compression effect and can effectively and efficiently deal with redundancies in data tokens, or non-uniform information distribution in the data tokens. In addition, latent tokens can allow the system to form longer-term memory, offering more efficient processing that requires fewer computing resources, such as fewer floating point operations and fewer processor cycles, when performing inference on a given input compared to conventional systems.

As an example, the conventional self-attention mechanism in a Transformer has a complexity of O(L²) where L is the number of tokens in the sequence. L can range from a few hundred to more than millions of tokens. The attention complexity of the system described in this specification is O(n²) within each group of n data tokens, and can reach O(L^{4/3}) globally. The system also requires fewer computing resources and time, for example, by requiring fewer floating point operations for processing, than conventional attention mechanisms. The system can enhance efficiency by relying on the global layers that perform adaptive computation. Furthermore, during training, the system can achieve lower loss and a higher training efficiency compared to a conventional Transformer-based encoder or decoder. Thus, relative to conventional systems, the system described in this specification can more efficiently (e.g., with decreased latency, requires fewer processor cycles, and/or requires less memory) perform inference on a given input.

The system supports a variety of tasks such as encoding and generation tasks, such as image, text, and video understanding and generation. For example, the system provides for a versatile architecture that can function as an encoder, a diffusion decoder, or an autoregressive decoder. The system supports autoregressive generation with improved memory usage and decoding speed compared to conventional systems because latent tokens can summarize earlier data tokens, enabling more efficient and compact processing that requires fewer processor cycles and less memory. The system can use causal masked attention and attention over shifted latents to ensure information does not flow from future data tokens to past data tokens. For example, the system can autoregressively generate images. The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 is a flow diagram of an example process for generating a network output at a time step.

FIG. 3 is a diagram of an example process for processing data tokens and sets of latent tokens at a time step.

FIG. 4 is a diagram of another example process for processing data tokens and sets of latent tokens at a time step.

FIG. 5 is a diagram of another example process for processing data tokens and sets of latent tokens at a time step.

Like reference numbers and designations in the various drawings indicate like elements.

### DETAILED DESCRIPTION

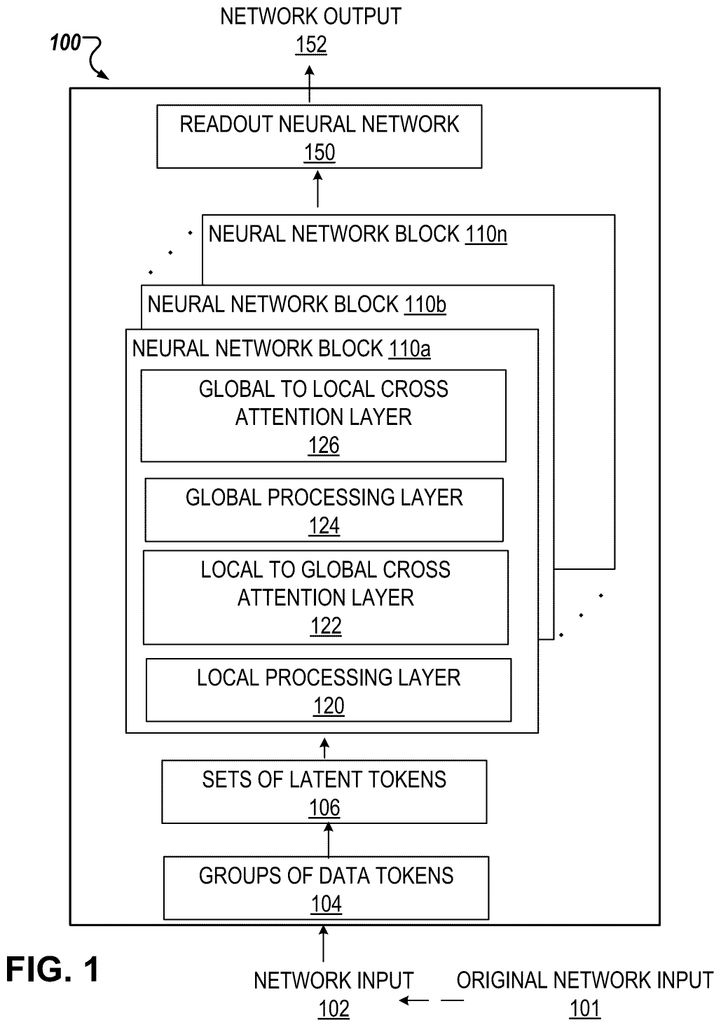

FIG. 1 is a diagram of an example neural network system 100. The system 100 is an example of a system implemented as computer programs on one or more computers in one or more locations, in which the systems, components, and techniques described below can be implemented.

The neural network system 100 is a system that generates a respective network output at each time step of a sequence of one or more time steps using a sequence of neural network blocks 110. A block refers to a group of one or more neural network layers in a neural network.

At each time step in the sequence of time steps, the system 100 obtains a network input 102 for the time step and generates a network output 152 for the time step using the sequence of neural network blocks 110.

The network input 102 at each time step includes multiple data tokens that represent a collection of data elements, e.g., a sequence of data elements, an unordered set of data elements, a two-dimensional array of data elements, or a higher-dimensional array of data elements. For example, the network input 102 can be denoted as x∈ [symbol] where b is the batch size, L is the number of data tokens, and c is the token dimension. The number of data tokens can be dependent on the size of the network input 102.

For example, the system 100 can generate the network input 102 from an original network input 101 for the time step that includes the collection of data elements. For example, the system 100 can map the data elements in the original network input 101 to data tokens.

For example, the data tokens can include a respective data token corresponding to each of multiple subgroups, e.g., overlapping or non-overlapping proper subgroups, of the data elements in the original network input 101. In some examples, the system 100 can generate each of the data tokens by processing the corresponding subgroup of data elements using an embedding operation. The data tokens can be considered to be embedding vectors, with at least some of the data tokens representing the original network input 101. Throughout this specification, an embedding refers to an ordered collection of numerical values, e.g., a vector or matrix of numerical values. Examples of data elements will be described below.

The network output 152 at each time step can be a collection of data elements. The network output 152 can have the same format as the original network input 101 or a different format. Examples of network outputs 152 for a given time step will be described below.

At any given time step, the system 100 generates, from at least the network input 102 for the time step, multiple groups of data tokens 104. That is, the system generates groups of data tokens 104 at least in part by grouping data tokens in the network input 102 into multiple groups. As an example, the system divides the network input 102 into data tokens of [symbol] where t represents the number of groups, and n represents the number of tokens per group, such that L=t×n.

As will be described in more detail below, the groups of data tokens 104 can optionally also include one or more additional vectors in addition to those vectors that are generated by mapping the data elements in the original network input 101.

The system 100 initializes multiple sets of latent tokens 106 for the time step. Each set in the set of latent tokens 106 corresponds to a respective group of data tokens in the groups of data tokens 104. Generally, the corresponding set of latent tokens for a group of data tokens includes a smaller number of tokens than the number of tokens in the group of data tokens. Moreover, the number of tokens in each set of latent tokens is fixed and independent of the size of the network input 102. For example, the latent tokens are of [symbol] where m<<n.

As an example, for an original network input that is a 64×64 pixel image, the system can group pixels into 8×8 patches, with 192 data tokens per group and a set of 32 latent tokens per group.

The system 100 processes the data tokens in each group of data tokens and the sets of latent tokens 106 through each neural network block in a sequence of neural network blocks 110 to update the groups of data tokens 104 and the sets of latent tokens 106.

Each neural network block (e.g., neural network block 110a, 110b, . . . 110n) is configured to update the groups of data tokens 104 and the sets of latent tokens 106. The output of the last neural network block in the sequence are updated groups of data tokens 104 and updated sets of latent tokens 106.

Each neural network block generally includes a local processing neural network 120 (also referred to as a first neural network), a local to global cross attention layer 122 (also referred to as a second neural network), a global processing neural network 124 (also referred to as a third neural network), and a global to local cross attention layer 126 (also referred to as a fourth neural network).

In some examples, the readout neural network described below does not require updates to the latent tokens. Thus, the last neural network block in the sequence does not update the latent tokens by processing the data tokens and/or the latent tokens using a local to global cross attention layer. In some examples, the last neural network block in the sequence does not process the data tokens and/or the latent tokens using a local to global cross attention layer and a global processing layer.

As an example, processing the data tokens and/or the latent tokens through a sequence of three neural network blocks can include processing the data tokens and/or the latent tokens using a local processing neural network, a local to global cross attention layer, a global processing neural network, and a global to local cross attention neural network for the first block; a local processing neural network, a local to global cross attention layer, a global processing neural network, and a global to local processing neural network for the second block; and a local processing neural network for the third neural network block.

As another example, processing the data tokens and/or the latent tokens through a sequence of three neural network blocks can include processing the data tokens and/or the latent tokens using a local processing neural network, a local to global cross attention layer, and a global processing neural network for the first block; a global to local cross attention neural network, a local processing neural network, a local to global cross attention layer, and a global processing neural network for the second block; and a global to local processing neural network and a local processing neural network for the third neural network block.

The first neural network block 110a in the sequence receives as input the groups of data tokens 104 generated from the network input 102 and the initialized sets of latent tokens 106. For example, the latent tokens can be represented as positional embeddings.

Each subsequent block in the sequence, e.g., 110b-110n, receives as input the groups of data tokens 104 after being updated by the preceding block and the sets of latent tokens 106 after being updated by the preceding block.

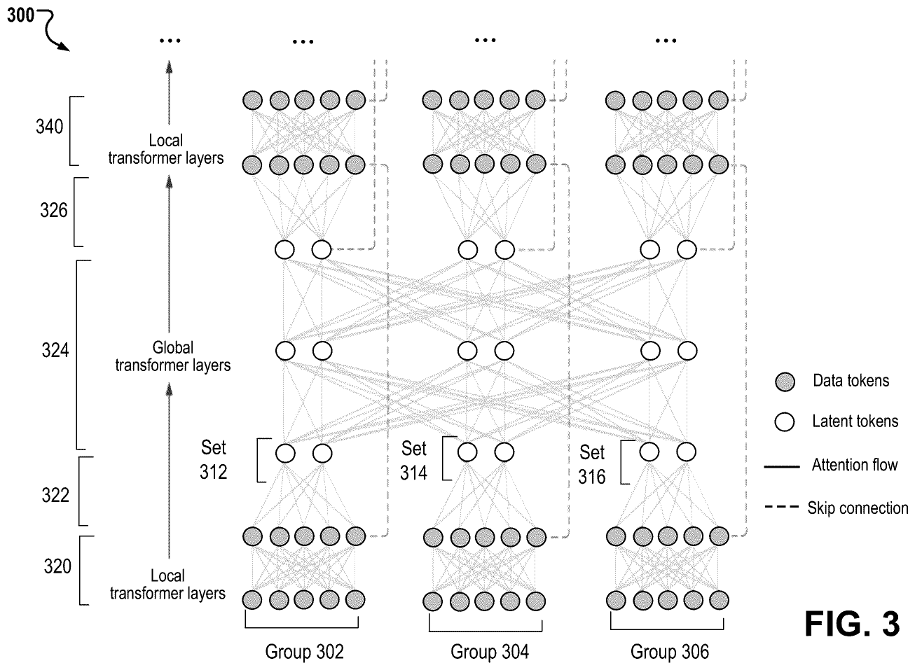

At each time step, the system uses the local processing neural network 120, the local to global cross attention layer 122, the global processing neural network 124, and the global to local cross attention layer 126 to update data tokens and latent tokens. Example forward passes for a time step are described below with reference to FIGS. 3-5.

The local processing neural network 120 is configured to update data tokens for each group of data tokens. In some implementations, the local processing neural network 120 includes multiple local transformer layers. For example, the local transformer layers can apply an attention mechanism such as self-attention to update each group. In some implementations, in addition to or alternatively to applying an attention mechanism, the local processing neural network 120 uses one or more convolutional layers to update each group. The local processing neural network 120 allows for localized information processing and capturing fine-grained relationships among data tokens within the group.

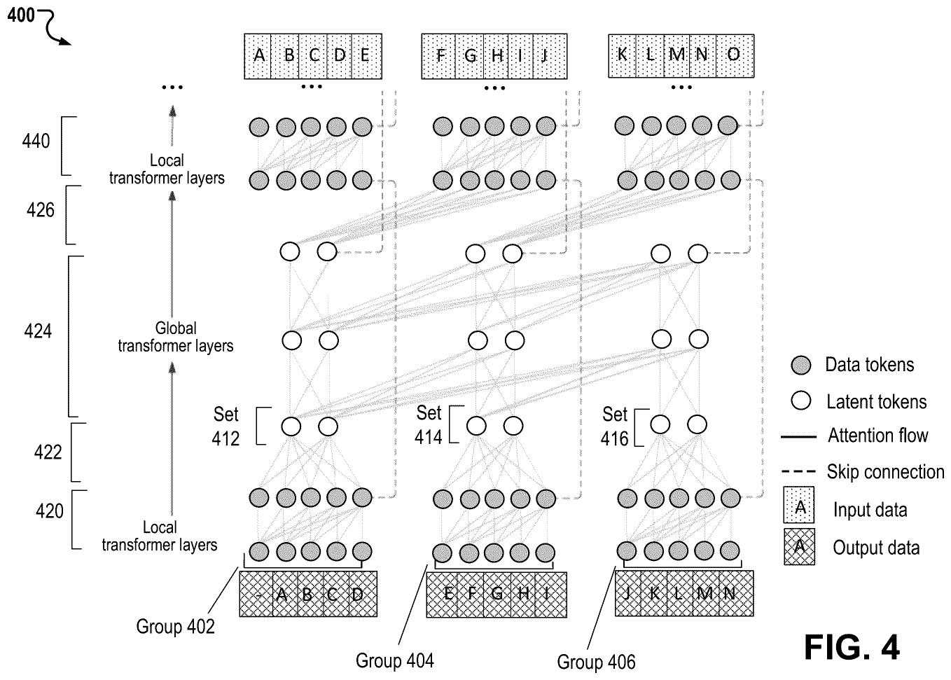

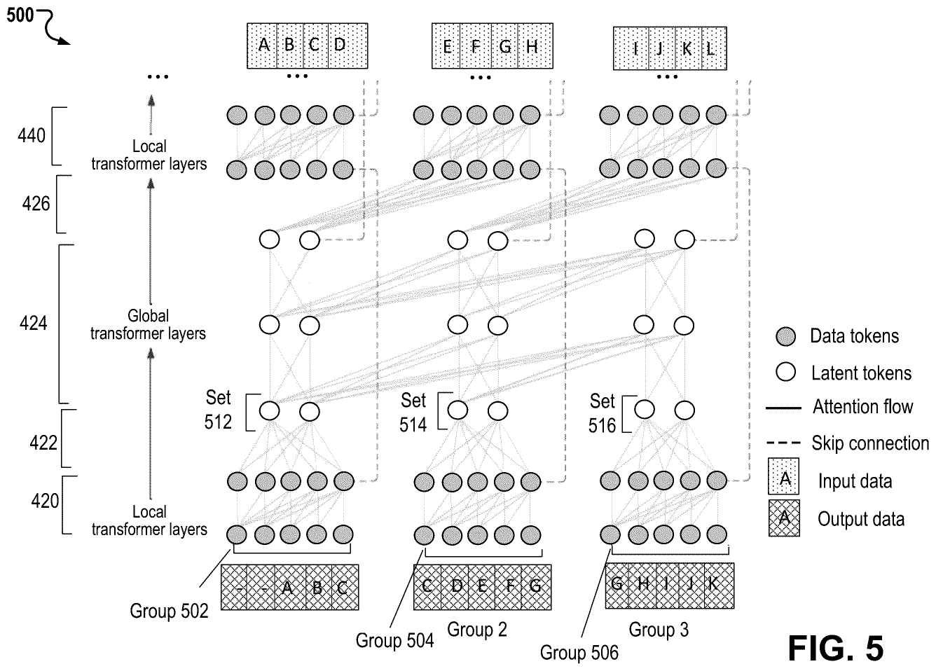

In some implementations, each data token is allowed to attend to every other data token, such as described with reference to FIG. 3. In some implementations, the local transformer layers apply causal attention, such as described with reference to FIGS. 4-5.

The local to global cross attention layer 122 is configured to update latent tokens for a corresponding set of a group of data tokens. For example, the local to global cross attention layer 122 is configured to apply attention over the latent tokens in the corresponding set and the data tokens of the group. The local to global cross attention layer 122 allows the latent tokens to selectively attend to the data tokens through cross attention.

The global processing neural network 124 is configured to update latent tokens in a set of latent tokens. For example, the global processing neural network 124 can include global transformer layers configured to apply attention over the sets of latent tokens 106. The global processing neural network 124 allows for capturing global dependencies and long-range relationships between different parts of the network input 102.

In some implementations, each latent token is allowed to attend to every other latent token in the set, such as described with reference to FIG. 3. In some implementations, the global transformer layers apply causal attention, such as described with reference to FIGS. 4-5.

The global to local cross attention layer 126 is configured to update data tokens for a corresponding set of latent tokens. For example, the global to local cross attention layer 126 is configured to apply attention over the sets of latent tokens and the data tokens of the group. The global to local cross attention layer 126 allows the data tokens to retrieve contextualized information from the latent tokens through cross attention.

The operations performed by the blocks 110 in the sequence will be described in more detail below with reference to FIG. 3.

In some implementations, the system 100 can autoregressively generate the network output. For example, the system 100 can generate the network output data token by data token. The operations performed by the blocks 110 in the sequence in these implementations will be described in more detail below with reference to FIGS. 4-5.

After processing the groups of data tokens 104 and the sets of latent tokens 106 through the sequence of neural network blocks 110, the system 100 processes the data tokens and/or the latent tokens using a readout neural network 150 to generate the network output 152 for the time step.

The readout neural network 150 can generally be any appropriate neural network that is configured to map the groups of data tokens and/or the sets of latent tokens to a collection of data elements that is in the format of the network output 152, i.e., to an output that has the required number of data elements or data tokens for the network output 152. For example, the readout neural network 150 can include one or more output heads that are configured to generate the output from the groups of data tokens and/or the sets of latent tokens, or from data generated by one or more preceding neural network layers that process the groups of data tokens and/or the sets of latent tokens. For example, an output head can process the groups of data tokens to generate a regression or classification output.

As an example, the readout neural network can apply an output head to the data tokens. As another example, the readout neural network can apply an output head to the latent tokens. In some examples, such as where the last neural network block in the sequence does not update the latent tokens, the readout neural network can update the latent tokens using the data tokens prior to applying the output head to the latent tokens. For example, the readout neural network 150 can update the latent tokens using the data tokens, e.g., using cross attention.

As another example, the readout neural network can apply an output head to the data tokens and the latent tokens. As another example, the readout neural network can apply an output head to the updated latent tokens without updating the data tokens.

For example, the readout neural network 150 can be a set of one or more linear neural network layers that are applied independently to each data token or latent token, a multi-layer perceptron (MLP) that is applied independently to each data token or latent token, a Transformer neural network or recurrent neural network that is applied sequentially across the groups of data tokens or sets of latent tokens, and so on. Generally, the system performs the sequence of time steps to generate a target output given the network input at the first time step.

In some implementations, there is only a single time step in the sequence. In these implementations, the network output at the time step defines the target output, i.e., is the target output or can be transformed into the target output.

In these implementations, the target output generated by the system can be a collection of data elements that represents any kind of entity.

The collection of data elements generated by the neural network can represent any appropriate entity. For example, each data element can represent a pixel in an image, and the collection of data elements can collectively represent the image.

As another example, each data element can represent an audio sample in an audio waveform, and the collection of data elements can collectively represent the audio waveform.

As another example, each data element can represent a musical note, and the collection of data elements can collectively represent a musical composition.

As another example, each data element can represent a pixel in a respective video frame of a video that includes multiple frames, and the collection of data elements can collectively represent the video.

As another example, each data element can represent a respective structure parameter from a set of structure parameters that collectively define a structure of a protein. As another example, each data element can represent an amino acid, and the collection of data elements can collectively represent an amino acid sequence of a protein.

As another example, each data element can represent a text symbol, e.g., a character, word piece, or word, and the collection of data elements can collectively represent a piece of text, e.g., natural language text or computer code.

As another example, the target output can represent a structured output or a classification output for an original network input 101 that represents any appropriate entity.

For example, the structured output can be a semantic segmentation, instance segmentation, or a panoptic segmentation output for an original network input 101 that is an image, a point cloud, or a video. As another example, the structured output can be an object detection output, optical flow output, a depth prediction output, or other computer vision output for an original network input 101 that is an image, a point cloud, or a video.

The classification output can be any appropriate classification output for a given entity above or other appropriate entity, e.g., an image classification output, an audio classification output, a video classification output, or a point cloud classification output, that classifies the entity into one or more of a plurality of classes.

More specifically, in an image or video classification task, the output may be an output indicating the presence of one or more object categories in the input image data. The indication may be a probability, a score or a binary indicator for a particular object category. In an object detection task, the output may be an output indicating a location of one or more objects that have been detected in the input image data. The indication may be a bounding box, set of coordinates or other location indicator and the output may further comprise a label indicating the corresponding detected object. In a depth estimation task, the output may be an output indicating an estimated depth of objects depicted in the image data. The output may be a depth map comprising an estimated depth value for each pixel of the input image data. The video classification task may be an action recognition task. The output may be an output indicating that one or more particular actions are being performed in the video. The output may comprise an output indicating the temporal and/or spatial location within the video that an action is being performed at.

If the original network input 101 is audio data, the audio data may comprise a speech signal. The neural network may be configured to carry out an audio processing task which may be a speech processing task such as speech recognition. The output may be output data comprising one or more probabilities or scores indicating that one or more words or sub-word units comprise a correct transcription of the speech contained within. Alternatively, the output data may comprise a transcription itself. The audio processing task may be a keyword (“hotword”) spotting task. The output may be an indication of whether a particular word or phrase is spoken in the input audio data. The audio processing task may be a language recognition task. The output may provide an indication or delineation of one or more languages present in the input audio data. The audio processing task may be a control task. The input audio data may comprise a spoken command for controlling a device and the output may comprise output data that causes the device to carry out actions corresponding to the spoken command.

In some other implementations, there are multiple time steps in the sequence.

In some of these implementations, the system 100 receives a new network input at each time step in the sequence and generates a respective target output at each time step in the sequence, so that the network output at each time step defines the target output at the time step, i.e., is the target output or can be transformed into the target output. For example, the network inputs can be interdependent, so that the previous network inputs provide context for generating the target output at a given time step. In these examples, the network inputs and target outputs can be any of those described above, but with new network inputs being provided at each time step.

In others of these implementations, the system iteratively generates a single target output across the multiple time steps. In these implementations, the network output at the final time step defines the target output, i.e., is the target output or can be transformed into the target output.

For example, the system can perform a reverse diffusion process across the multiple time steps to generate the target output.

At the first time step, the network input 102 includes data tokens representing a noisy version of the target output. That is, the original network input 101 is initialized to a noisy version of the target output, i.e., a version that has the same number of data elements as the target output but that includes at least some data elements that are sampled from a noise distribution.

At each iteration, the network input 102 includes data tokens representing the current version of the target output and the network output defines an estimate of the target output given the current version, e.g., is an estimate of the noise added to the target output to generate the current version as of the time step or is the estimate of the target output given the current version of the target output as of the time step.

The system 100 then uses the network output 152 at the iteration to update the current version of the target output, e.g., using any appropriate diffusion model state transition rule, e.g., DDIM (further details of which can be found in J. Song et al., Denoising Diffusion Implicit Models, ICLR 2021, which is hereby incorporated by reference in its entirety), DDPM (further details of which can be found in J. Ho et al., Denoising Diffusion Probabilistic Models, NeurIPS, 2020, which is hereby incorporated by reference in its entirety), or another appropriate state transition rule.

After the last iteration, the system 100 uses the updated version of the target output as the final estimate of the target output, i.e., as the target output that is provided by the system 100.

In these cases, the system 100 can generate a target output that is a collection of data elements that represent any appropriate entity, e.g., one of the entities described above, across the multiple time steps.

In some examples, the system 100 can autoregressively generate the network output one data token at a time. That is, the system can generate each data token in an output sequence conditioned on a current input sequence that includes any data tokens that precede the particular data token in the output sequence, i.e., the tokens that have already been generated for any previous positions in the output sequence that precede the particular position of the particular data token. The system can generate the logits for predicting the next token from the data tokens, for example.

In some examples, such as where the network output includes a sequence of data elements that can be represented by data tokens, the readout neural network 150 can be any appropriate neural network that is configured to map the groups of data tokens or the sets of latent tokens or both to a data element that can be represented by a new data token. The data element can be added at the end of a current data element output sequence. In some examples, such as where the network output includes a sequence of data tokens, the readout neural network can be configured to map the groups of data tokens or the sets of latent tokens or both to a new data token that can be added at the end of a current data token output sequence.

As an example, the readout neural network can apply an output head to the data tokens. As another example, the readout neural network can apply an output head to the latent tokens. In some examples, such as where the last neural network block in the sequence does not update the latent tokens, the readout neural network can update the latent tokens using the data tokens prior to applying the output head to the latent tokens. As another example, the readout neural network can apply an output head to the data tokens and the latent tokens. As another example, the readout neural network can apply an output head to the updated latent tokens without updating the data tokens.

An example of a task that can be done autoregressively includes a text generation task, where the original network input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

As another example, the task can be an image generation task, where the original network input is a conditioning input and the output is a sequence of intensity value inputs for the pixels of an image.

As another example, the task can be an agent control task, where the original network input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent.

As another example, the task can be an audio generation task, where the original network input is a conditioning input, e.g., an image, text, or audio, and the output is a sequence of audio data that describes the conditioning input or follows the conditioning input in a larger sequence.

As one example, if the original network input to the neural network is a sequence of text in one language, the output generated by the neural network can be a sequence of text in another language that is a translation of the input text into the other language.

As another example, the task can be a computer code generation task, where the original network input is a conditioning input, e.g., text describing the intended function of a piece of code, and the output is a sequence of code in a programming language that performs the intended function or the input is code in a programming language and the output is a sequence of code that is predicted to follow the input code in a computer program.

More generally, the system 100 can generate target outputs for any task that requires operating on tensors that include a large number of data elements, e.g., a structured prediction task that requires generating a structured output for an original network input 101 that has a large number of data elements, a generative task that requires generating a target output that has a large number of data elements (e.g., the generation of an image, video or audio signal), or a classification task that requires generating a classification output for an original network input 101 that has a large number of data elements.

In some implementations, the system 100 can be conditioned on data that specifies one or more desired characteristics of the collection of data elements to be generated by the system. A few examples of conditioning data are described next.

In one example, the conditioning data can characterize a sequence of text, and when conditioned on the conditioning data, the system 100 can generate a collection of data elements that represents a verbalization of the sequence of text. For example, the data elements may be elements (e.g., samples) of an audio signal that comprises a spoken utterance corresponding to the sequence of text.

As another example, the conditioning data can define a set of properties of a protein (e.g., stability, solubility, etc.), and when conditioned on the conditioning data, the system 100 can generate data defining a protein that is predicted to have the properties specified by the conditioning data.

As another example, the conditioning data can specify one or more features of an image or a video (e.g., an object shown in the image), and when conditioned on the conditioning data, the system 100 can generate an image or a video having the features specified by the conditioning data. The features can be specified as, e.g., a class label from a set of possible object class labels or a natural language text sequence that describes the features of the image or video.

As another example, the conditioning data can specify one or more features of a point cloud (e.g., an object characterized by the point cloud), and when conditioned on the conditioning data, the system 100 can generate a point cloud having the features specified by the conditioning data.

As another example, the conditioning data can specify one or more features of a sequence of text (e.g., a topic of the sequence of text, a question about the text, an initial portion of computer program code), and when conditioned on the conditioning data, the system 100 can generate a sequence of text having the features specified by the conditioning data.

The system 100 can implement this conditioning in any of a variety of ways.

For example, the system 100 can map the conditioning input to one or more conditioning embeddings and include the conditioning embedding(s) in the sets of latent tokens, the groups of data tokens, or both. The system can perform this mapping by processing the conditioning input using an embedding neural network that is appropriate for the type of conditioning input. For example, when the conditioning input is text, the embedding neural network can be a text embedding neural network, e.g., an RNN or a Transformer. For example, when the conditioning input is audio, the embedding neural network can be an audio embedding neural network, e.g., an RNN or a Transformer. For example, when the conditioning input is an image, the embedding neural network can be an image embedding neural network, e.g., a convolutional neural network or a vision Transformer.

As another example, for a task that requires generating a target output that is a completion of an initial target output that is provided to the system as a conditioning input, the system 100 can represent the original network input at each iteration (time step) as one or more fixed data elements that correspond to the data elements that are included in the conditioning input and a plurality of unfixed (i.e., variable) data elements that need to be completed by the system 100.

For example, the system 100 can fix one or more initial video frames that are provided as input and generate the remainder of the video frames in the video as described above. As another example, the system 100 can fix a portion of the pixel values in an image and generate the remainder of the pixel values as described above. As yet another example, the system 100 can fix a set of points from a point cloud that are provided as input and generate the remainder of the points in the point cloud as described above. As yet another example, the system 100 can fix a portion of a text sequence that is provided as input and generate the remainder of the text sequence as described above.

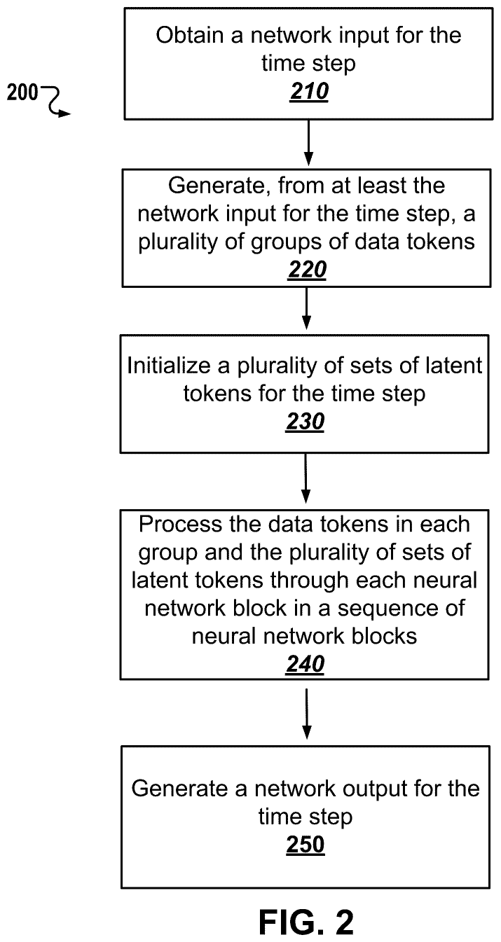

FIG. 2 is a flow diagram of an example process 200 for generating a network output at a time step. For convenience, the process 200 will be described as being performed by a system of one or more computers located in one or more locations. For example, a neural network system, e.g., the neural network system 100 of FIG. 1, appropriately programmed, can perform the process 200.

The system can perform the process 200 for each time step in a sequence of one or more time steps. That is, in some implementations, there is only a single time step and the system performs only a single iteration of the process 200. In other implementations, there are multiple time steps, with a respective network input at each time step as described above, and the system performs multiple iterations of the process 200 to generate a respective network output for each network input.

The system obtains a network input for the time step (step 210). Generally, as described above, the network input includes data tokens that represent a collection of data elements.

In some implementations, the system can generate the network input from an original network input for the time step that includes a collection of data elements. For example, the system can generate a respective data token from each of multiple subgroups of the collection of data elements. For example, each data token can include an embedding of each subgroup of data elements. As an example, if the original network input is an image, each data token can represent a patch embedding vector.

For example, for each of the multiple subgroups, the system can apply one or more learned projection layers to the data elements in the subgroup to generate the respective data token for the subgroup.

As another example, the system can apply a different learned transformation to the data elements in the subgroup, e.g., a Transformer or a recurrent neural network or an MLP.

As another example, the system can process the original network input using an encoder neural network, e.g., a convolutional neural network or a Transformer neural network, to generate the data tokens.

In any of the above examples, the learned transformation, the encoder neural network, or the learned projection layers can be pre-trained prior to the training of the sequence of neural network blocks or learned jointly with the training of the sequence of neural network blocks.

In some examples, each data token also includes a positional encoding. For example, the positional encoding can represent the ordering of the data token within the network input. The positional encoding can be pre-determined, e.g., sinusoidal, or can be learned during the training of the sequence of neural network blocks.

The system generates, from at least the network input for the time step, multiple groups of data tokens (step 220). For example, the system can group the data tokens into multiple groups of data tokens. In some examples, each group of data tokens includes one or more conditioning embedding vectors and/or time step embedding vectors.

For example, the system can generate groups of data tokens by splitting or reshaping the network input into sub-sequences. As an example, each group of data tokens can represent a sub-image of an original network input that is an image. As another example, text tokens from a book can be grouped into chapters.

Each group of data tokens can include less than all of the data tokens in the network input, e.g., each group is a different partition of the data tokens so that each data token is included in only one group. In some implementations, each group of data tokens can include overlapping partitions of the data tokens so that one data token can be included in more than one group but each group still contains only a proper subset of the data tokens in the network input.

In some examples, such as where the system generates the network output autoregressively, the system can generate one group of data tokens for the time step. For example, the network input for the time step can include a smaller number of tokens than a predetermined number of tokens per group.

The system initializes multiple sets of latent tokens for the time step (step 230). Each set corresponds to a respective one of the multiple groups of data tokens. Generally, each group of data tokens includes a larger number of tokens than the number of tokens in the corresponding set of latent tokens. For example, the number of tokens in a group of data tokens is dependent on a size of the network input, while the number of tokens in each set of latent tokens can be fixed and thus independent of the size of the network input. In some examples, the system initializes the latent tokens independently from the network input for the time step.

In some examples, such as where the system generates the network output autoregressively, the system can generate one set of latent tokens for the time step. For example, there can be one group of data tokens.

Generally, the system initializes at least some of the latent tokens in each set using a set of learned latent embedding vectors that are learned during the training of the neural network blocks in the sequence.

That is, the sets of latent tokens each include a subset of latent tokens that are initialized using the set of learned latent embedding vectors. In some implementations, the subset is not a proper subset and all of the latent tokens are initialized using the set of learned latent embedding vectors. In some other implementations, the subset is a proper subset that includes less than all of the latent tokens, and some of the latent tokens are not initialized using the set of learned latent embedding vectors.

For example, as described above, some of the latent tokens can be determined based on the conditioning input to the neural network.

As another example, when the sequence of time steps includes multiple time steps, at any given time step each set of latent tokens can include one or more latent tokens that represent an embedding of the given time step, i.e., that are generated by mapping an identifier for the given time step to one or more embedding vectors. The mapping can be pre-determined, e.g., sinusoidal, or can be learned during the training of the sequence of neural network blocks.

For the subset that is initialized using the set of learned latent embedding vectors, in some implementations, the system initializes the subset of the latent tokens to be equal to the set of learned latent embedding vectors, i.e., initializes each latent token in the subset by setting the latent token equal to a corresponding one of the learned latent embedding vectors.

In some other implementations, when the sequence of time steps includes a plurality of time steps, at any given time step the system initializes the subset of latent tokens using a preceding set of latent tokens. The preceding set of latent tokens are the subset of the set of latent tokens for a preceding time step after being updated by the last neural network block in the sequence at the preceding time step. That is, the preceding set of latent tokens are the latent tokens (in the subset) after being updated by the last neural network block of the sequence at the preceding time step.

In particular, the system initializes the subset of the latent tokens by combining the preceding set of latent tokens with the set of learned latent embeddings. For example, for each latent token in the subset, the system can combine the corresponding preceding latent token with the corresponding learned latent embedding to initialize the latent token by applying one or more learned transformations to the preceding latent token to generate a transformed latent token and then adding the transformed latent token and the learned latent embedding.

The system processes the data tokens in each group and the multiple sets of latent tokens through each neural network block in a sequence of neural network blocks (step 240). The system updates the multiple groups of data tokens and the plurality of sets of latent tokens. The operations performed by the neural network blocks in the sequence are described in further detail with reference to FIGS. 3-5.

The system generates a network output for the time step (step 250). After processing each group of data tokens and the latent tokens through the sequence of neural network blocks, the system generates the network output for the time step from the data tokens, the latent tokens, or both. For example, the system can process the data tokens and/or latent tokens using a readout neural network to generate a network output for the time step. As described above, the architecture of the readout neural network will generally depend on the format of the network output for the time step.

Prior to using the sequence of neural network blocks, the system or a training system trains the sequence of neural network blocks and the other learned components of the system, e.g., the learned latent embeddings, the readout network and, optionally, the learned transformations used to generate the data tokens, jointly on training data.

Generally, the training system trains these components on training data that is appropriate for the task that the system is configured to perform and on an objective function that is appropriate for the task.

For example, when the system performs a reverse diffusion process after training, the training system can train the components on a diffusion model training objective, e.g., a score matching objective.

As another example, when the system performs a classification task, the system can train the components on a classification objective, e.g., a cross-entropy loss.

As another example, when the system performs a regression task, the system can train the components on a regression objective, e.g., a mean-squared error loss, an 12 distance loss, and so on.

As another example, when the system performs an autoregressive task, the system can train the components on an objective function such as a cross-entropy objective function.

FIG. 3 is a diagram of an example process 300 for processing data tokens and sets of latent tokens at a time step. The process 300 is an example of a forward pass through a sequence of one or more neural network blocks at one time step, performed as part of step 240 of FIG. 2.

FIG. 3 shows three groups of data tokens, group 302, group 304, and group 306. Each group includes five data tokens. FIG. 3 also shows three sets of latent tokens, each corresponding to one of the groups of data tokens. For example, set 312 corresponds to group 302, set 314 corresponds to group 304, and set 316 corresponds to group 306. Each set includes two latent tokens.

At the time step, the system processes groups of data tokens and sets of latent tokens using a local processing neural network 320, a local to global cross attention layer 322, a global processing neural network 324, and a global to local cross attention layer 326. In some examples, applying attention includes applying multi-head attention. Multi-ahead attention (MHA) is described in more detail in, e.g., Vaswani, A., Shazeer, N., Parmar, N., Uszkoreit, J., Jones, L., Gomez, A. N., Kaiser, Ł., and Polosukhin, I. Attention is all you need. Advances in neural information processing systems, 30, 2017.

The local processing neural network 320, local to global cross attention layer 322, global processing neural network 324, and global to local cross attention layer 326 are examples of the local processing neural network 120, local to global cross attention layer 122, global processing neural network 124, and global to local cross attention layer 126, respectively, described above with reference to FIG. 1.

For each group of data tokens, the system processes the data tokens in the group using the local processing neural network 320 to update the data tokens in the group. For example, the system processes the data tokens in each group of groups 302, 304, and 306 to update the data tokens in the group. The local processing neural network 320 is configured to apply attention over the data tokens of the group with keys and queries and values derived from the data tokens. In the example of FIG. 3, the local processing neural network 320 uses one or more transformer layers that apply an attention mechanism such as self-attention. Each local transformer layer can also include other neural network layers such as a feed-forward network. The local transformer layers operate on the data tokens within each group independently and concurrently.

For example, the local processing neural network 320 can apply attention over the data tokens of group 302 with keys, queries, and values derived from the data tokens of group 302. FIG. 3 shows the attention flow among the tokens of group 302, among the tokens of group 304, and among the tokens of group 306. For example, each data token in group 302 attends to itself and each other data token in the group.

In some examples, the local processing neural network of a subsequent neural network block receives as input, e.g., through skip connections, the groups of data tokens 302, 304, and 306 after being updated by the local processing neural network of the preceding block.

After updating the data tokens in each group using the local processing neural network 320, for each group of data tokens, the system processes the data tokens in the group and the latent tokens in the corresponding set for the group using the local to global cross attention layer 322 to update the latent tokens in the corresponding set for the group. The local to global cross attention layer 322 is configured to apply attention over the latent tokens in the corresponding set and the data tokens of the group with queries derived from the latent tokens and keys and values derived from the data tokens.

For example, the local to global cross attention layer 322 can apply attention over the set 312 and the group 302. For example, the local to global cross attention layer 322 can apply cross attention with queries derived from the latent tokens of the set 312 and keys and values derived from the data tokens of the group 302. FIG. 3 shows the attention flow between the data tokens of the group 302 and the latent tokens of the set 312. For example, each latent token in the set 312 attends to each data token in the group 302.

After updating the latent tokens in the corresponding set for each group using the local to global cross attention layer, the system processes the sets of latent tokens using the global processing neural network 324 to update the latent tokens. The global processing neural network 324 is configured to apply attention over the sets of latent tokens with keys and queries and values derived from the sets of latent tokens. The global processing neural network 324 includes one or more global transformer layers that apply an attention mechanism such as self-attention. Each global transformer layer can also include other neural network layers such as a feed-forward network.

For example, the global processing neural network 324 can apply attention over the latent tokens of the sets 312, 314, and 316. For example, the global processing neural network 324 can apply attention with keys, queries, and values derived from the sets 312, 314, and 316. FIG. 3 shows the attention flow between latent tokens across the sets 312, 314, and 316. For example, each latent token in the set 312 attends to itself and each other latent token in the set 312, as well as the latent tokens of sets 314 and 316.

In some examples, the global processing neural network of a subsequent neural network block receives as input, e.g., through skip connections, the sets of latent tokens 312, 314, and 316 after being updated by the global processing neural network of the preceding block.

For each group of data tokens, the system processes the data tokens in the group and the latent tokens in the corresponding set using the global to local cross attention layer 326 to update the data tokens in the group. The global to local cross attention layer 326 is configured to apply attention over the corresponding set and the data tokens of the group with keys and values derived from the latent tokens and queries derived from the data tokens.

For example, the global to local cross attention layer 326 can apply attention over the set 312 and the group 302. For example, the global to local cross attention layer 326 can apply attention with keys and values derived from the latent tokens of the set 312 and queries derived from the data tokens of the group 302. FIG. 3 shows the attention flow between the latent tokens of the set 312 and the data tokens of the group 302. For example, each data token in the group 302 attends to each latent token in the set 312.

In some examples, the system uses the global to local cross attention layer 326 after the global processing neural network 324 as part of the same neural network block as the global processing neural network 324. The subsequent neural network block receives data tokens updated by the global to local cross attention layer 326 and latent tokens updated by the global processing neural network 324 from the preceding neural network block. For example, after processing the sets of latent tokens using the global processing network 324 to update the latent tokens, for each group of data tokens, the system uses the global to local cross attention layer 326 to process the data tokens in the group and the latent tokens in the corresponding set to update the data tokens in the group.

In some examples, the system uses the global to local cross attention layer 326 after the global processing neural network 324 as part of the subsequent neural network block to the neural network block of the global processing neural network 324. That is, the subsequent neural network block receives latent tokens updated by the global processing neural network 324 and data tokens updated by the local processing neural network 320 from the preceding neural network block. The subsequent neural network block uses the global to local cross attention layer 326 prior to using the local processing neural network for the block. For example, each subsequent block processes, for each group of data tokens, the data tokens in the group and the latent tokens in the corresponding set using the global to local cross attention layer to update the data tokens in the group. The subsequent block then processes, for each group of data tokens, the data tokens in the group using the local processing neural network to update the data tokens in the group.

FIG. 3 also shows another local processing neural network 340 following the global to local cross attention layer 326. For example, the local processing neural network 340 is part of a subsequent neural network block.

FIG. 4 is a diagram of another example process 400 for processing data tokens and sets of latent tokens at a time step. The process 400 is an example of a forward pass through a sequence of one or more neural network blocks at one time step, performed as part of step 240 of FIG. 2. The process 400 is similar to the process 300 described above with reference to FIG. 3, but shows an example process for autoregressively generating the network output.

FIG. 4 shows three groups of data tokens, group 402, group 404, and group 406 after 15 time steps. Each group includes five data tokens. FIG. 4 also shows three sets of latent tokens, each corresponding to one of the groups of data tokens. For example, set 412 corresponds to group 402, set 414 corresponds to group 404, and set 416 corresponds to group 406. Each set includes two latent tokens.

FIG. 4 also shows the input data or network input, and output data or network output generated using the readout neural network for the time step. For example, in examples where the network output includes a data token output sequence, the next-token prediction for the data token “B” in group 402 of the network input is represented in the network output for group 402 as token “C.” The token “C” in the network output is generated conditioned on the tokens generated previously, which includes the tokens “A” and “B” of the network output. After generating the token “C” in the network output, the system can conditionally generate the token “D” in the network output based on the tokens generated previously, e.g., tokens “A,” “B,” and “C” of the network output, and so on.

Each time the system generates the token at a current position in the network output, it can include the token in the network input for the next time step. That is, the network input for each time step other than the first time step is updated to include the generated tokens for the previous time step.

In examples where the network output includes a sequence of data elements that can be represented by data tokens, the next-token prediction for the data token “B” in group 402 of the network input is a token representing “C” in the network output. The token representing “C” in the network output is generated conditioned on the tokens generated previously, which includes the tokens representing “A” and “B” of the network output. After generating the token representing “C” in the network output, the system can conditionally generate the token representing “D” in the network output based on the tokens generated previously, e.g., tokens representing “A,” “B,” and “C” of the network output, and so on.

Each time the system generates the token representing a data element at a current position in the network output, it can include the token in the network input for the next time step.

At each time step, the system processes one or more groups of data tokens and one or more sets of latent tokens using a local processing neural network 420, a local to global cross attention layer 422, a global processing neural network 424, and a global to local cross attention layer 426. In some examples, applying attention includes applying multi-head attention.

The local processing neural network 420, local to global cross attention layer 422, global processing neural network 424, and global to local cross attention layer 426 are examples of the local processing neural network 120, local to global cross attention layer 122, global processing neural network 124, and global to local cross attention layer 126, respectively, described above with reference to FIG. 1.

For each group of data tokens, the system processes the data tokens in the group using the local processing neural network 420 to update the data tokens in the group. For example, the system processes the data tokens in each group of groups 402, 404, and 406 to update the data tokens in the group. The local processing neural network 420 is configured to apply attention over the data tokens of the group with keys and queries and values derived from the data tokens. In the example of FIG. 4, the local processing neural network 420 includes, for each group, a local transformer layer that applies self-attention. Each local transformer layer can also include other neural network layers such as a feed-forward network. Each local transformer layer operates on the data tokens within the corresponding group independently and concurrently.

For example, the local processing neural network 420 can apply causal masked attention over the data tokens of group 402 with keys, queries, and values derived from the data tokens of group 402. FIG. 4 shows the attention flow among the tokens of group 402, among the tokens of group 404, and among the tokens of group 406. For example, in order to prevent leakage of future information into the past (e.g., during training), each data token does not attend to every other data token.

In some examples, the local processing neural network of a subsequent neural network block receives as input, e.g., through skip connections, the groups of data tokens 402, 404, and 406 after being updated by the local processing neural network of the preceding block.

After updating the data tokens in each group using the local processing neural network 420, for each group of data tokens, the system processes the data tokens in the group and the latent tokens in the corresponding set for the group using the local to global cross attention layer 422 to update the latent tokens in the corresponding set. The local to global cross attention layer 422 is configured to apply attention over the latent tokens in the corresponding set for the group and the data tokens of the group with queries derived from the latent tokens and keys and values derived from the data tokens.

For example, the local to global cross attention layer 422 can apply attention over the set 412 and the group 402. For example, the local to global cross attention layer 422 can apply cross attention with queries derived from the latent tokens of the set 412 and keys and values derived from the data tokens of the group 402. FIG. 4 shows the attention flow between the data tokens of the group 402 and the latent tokens of the set 412. For example, each latent token in the set 412 attends to each data token in the group 402.

After updating the latent tokens in the corresponding set for each group using the local to global cross attention layer, the system processes the sets of latent tokens using the global processing neural network 424 to update the latent tokens. The global processing neural network 424 is configured to apply attention over the sets of latent tokens with keys and queries and values derived from the sets of latent tokens. The global processing neural network 324 includes one or more global transformer layers that apply self-attention. Each global transformer layer can also include other neural network layers such as a feed-forward network.

For example, the global processing neural network 424 can apply causal masked attention over the latent tokens of the sets 412, 414, and 416. For example, the global processing neural network 424 can apply attention with keys, queries, and values derived from the sets 412, 414, and 416. FIG. 4 shows the attention flow between latent tokens across the sets 412, 414, and 416. For example, in order to prevent leakage of future information into the past, the latent tokens of set 412 attend only to each other, the latent tokens of set 414 attend to each other and the latent tokens of set 412, and the latent tokens of set 416 attend to each other, the latent tokens of set 414, and the latent tokens of set 412.

As another example, for the first five time steps, the global processing neural network 424 is configured to apply attention over the set 412. For the sixth through tenth time steps, the global processing neural network 424 is configured to apply attention over the set 414 and between the sets 412 and 414. For the eleventh through fifteenth time steps, the global processing neural network 424 is configured to apply attention over the set 416, between the sets 412 and 416, and between the sets 414 and 416.

For each group of data tokens other than the first group of data tokens, the system processes the data tokens in an immediately preceding group and the latent tokens in the corresponding set using the global to local cross attention layer 426 to update the data tokens in the group. The global to local cross attention layer 426 is configured to apply attention over the corresponding set and the data tokens of the preceding group with keys and values derived from the latent tokens and queries derived from the data tokens.

For example, the global to local cross attention layer 426 can apply attention over the set 412 and the group 404. For example, the global to local cross attention layer 426 can apply attention with keys and values derived from the latent tokens of the set 412 and queries derived from the data tokens of the group 404. FIG. 4 shows the attention flow between the latent tokens of the set 412 and the data tokens of the group 404. For example, in order to prevent leakage of future information into the past, the data tokens of group 404 attend to the latent tokens of set 412, and the data tokens of group 406 attend to the latent tokens of set 414.

In some examples, the global processing neural network of a subsequent neural network block receives as input, e.g., through skip connections, the sets of latent tokens 412, 414, and 416 after being updated by the global processing neural network of the preceding block.

In some examples, the system uses the global to local cross attention layer 426 after the global processing neural network 424 as part of the same neural network block as the global processing neural network 424. That is, the subsequent neural network block receives data tokens updated by the global to local cross attention layer 426 and latent tokens updated by the global processing neural network 424.

In some examples, the system uses the global to local cross attention layer 426 after the global processing neural network 424 as part of the subsequent neural network block to the neural network block of the global processing neural network 424. That is, the subsequent neural network block receives latent tokens updated by the global processing neural network 424 and data tokens updated by the local processing neural network 420 from the preceding neural network block. The subsequent neural network block uses the global to local cross attention layer 426 prior to using the local processing neural network for the block. For example, each subsequent block processes, for each group of data tokens, the data tokens in the group and the latent tokens in the corresponding set using the global to local cross attention layer to update the data tokens in the group. The subsequent block then processes, for each group of data tokens, the data tokens in the group using the local processing neural network to update the data tokens in the group.

FIG. 4 also shows another local processing neural network 440 following the global to local cross attention layer 426. For example, the local processing neural network 440 is part of a subsequent neural network block.

In some implementations, for each group of data tokens other than the first group of data tokens, the system processes the data tokens in an immediately preceding group and the latent tokens in the corresponding set using the local to global cross attention layer 422 to update the latent tokens in the corresponding set. In these implementations, the local to global cross attention layer 422 is configured to apply attention over the latent tokens in the corresponding set and the data tokens in an immediately preceding group.

For example, in order to prevent leakage of information into the past, the local to global cross attention layer 422 can apply attention over the set 414 and the group 402. For example, the local to global cross attention layer 422 can apply cross attention with queries derived from the latent tokens of the set 414 and keys and values derived from the data tokens of the group 402.

In these implementations, for each group of data tokens, the system processes the data tokens in the group and the latent tokens in the corresponding set using the global to local cross attention layer 426 to update the data tokens in the group. The global to local cross attention layer 426 is configured to apply attention over the corresponding set and the data tokens of the group with keys and values derived from the latent tokens and queries derived from the data tokens.

For example, the global to local cross attention layer 426 can apply attention over the set 412 and the group 402. For example, the global to local cross attention layer 426 can apply attention with keys and values derived from the latent tokens of the set 412 and queries derived from the data tokens of the group 402.

FIG. 5 is a diagram of another example process 500 for processing data tokens and sets of latent tokens at a time step. The process 500 is an example of a forward pass through a sequence of one or more neural network blocks at one time step, performed as part of step 240 of FIG. 2. The process 500 is similar to the process 400 described above with reference to FIG. 4, but shows an example with overlapped grouping of data tokens. Overlapped grouping of data tokens can lower the possibility that adjacent and highly dependent tokens are separated when they are grouped into different groups.

FIG. 5 shows three groups of data tokens, group 502, group 504, and group 506. Each group includes five data tokens. FIG. 5 also shows three sets of latent tokens, each corresponding to one of the groups of data tokens. For example, set 512 corresponds to group 502, set 514 corresponds to group 504, and set 516 corresponds to group 506. Each set includes two latent tokens.

At the time step, the system processes groups of data tokens and sets of latent tokens using the local processing neural network 420, a local to global cross attention layer 422, a global processing neural network 424, and a global to local cross attention layer 426, as described with reference to FIG. 4.

FIG. 5 shows that, in some implementations, the system can group the data tokens with overlapped grouping. For example, each group of data tokens can include overlapping partitions of the data tokens, so that one or more data tokens can be included in more than one group. For example, groups 502 and 504 include the data token “C”, and groups 504 and 506 include the data token “G.” “C” and “G” are referred to as prefix tokens from a previous group.

Tokens from a previous group can provide for additional direct conditioning. In these implementations, tokens from a preceding group that appear in a group are a prefix and do not directly predict the next tokens. That is, the next-token predictions for prefix tokens are discarded.

In examples where the network output includes a data token output sequence, the next-token prediction for the data token “C” in group 502 is the token “D” in group 502. For the prefix token “C” in group 504, the system discards the next-token prediction “D”, which is not included in the network output for group 504. As another example, the next-token prediction for the data token “G” in group 504 is the token “H” in group 504. For the prefix token “G” in group 506, the system discards the next-token prediction “H”, which is not included in the network output for group 506.

In examples where the network output includes a sequence of data elements that can be represented by data tokens, the next-token prediction for the data token “C” in group 502 is a token representing “D”. For the prefix token “C” in group 504, the system discards the next-token prediction representing “D”, which is not included in the network output for group 504. As another example, the next-token prediction for the data token “G” in group 504 is a token representing “H”. For the prefix token “G” in group 506, the system discards the next-token prediction representing “H”, which is not included in the network output for group 506.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising, at each time step in a sequence of one or more time steps:
obtaining a network input for the time step, wherein the network input comprises a plurality of data tokens;
generating, from at least the network input for the time step, a plurality of groups of data tokens;
initializing a plurality of sets of latent tokens for the time step, each set corresponding to a respective one of the plurality of groups;
processing the data tokens in each group and the plurality of sets of latent tokens through each neural network block in a sequence of neural network blocks to update the plurality of groups of data tokens and the plurality of sets of latent tokens, wherein each neural network block in the sequence is configured to perform operations comprising:
   for each group of data tokens, processing the data tokens in the group using a first neural network to update the data tokens in the group;
   after processing the data tokens in the group using the first neural network to update the data tokens in the group, for each group of data tokens, processing the data tokens in the group and the latent tokens in the corresponding set using a second neural network to update the latent tokens in the corresponding set;
   after processing, for each group, the data tokens in the group and the latent tokens in the corresponding set using the second neural network to update the latent tokens in the corresponding set, processing the plurality of sets of latent tokens using a third neural network to update the latent tokens;
after processing each group of data tokens and the latent tokens through the sequence of neural network blocks to update the plurality of groups of data tokens and the plurality of sets of latent tokens, generating a network output for the time step from the data tokens, the latent tokens, or both.

Embodiment 2 is the method of embodiment 1, wherein each neural network block in the sequence after a first neural network block in the sequence is further configured to perform operations comprising:
prior to processing, for each group of data tokens, the data tokens in the group using the first neural network to update the data tokens in the group, for each group of data tokens, processing the data tokens in the group and the latent tokens in the corresponding set using a fourth neural network to update the data tokens in the group.

Embodiment 3 is the method of any of embodiments 1-2, wherein generating a network output for the time step from the data tokens, the latent tokens, or both comprises using a readout neural network to generate a network output for the time step.

Embodiment 4 is the method of any of embodiments 1-3, wherein for each group of data tokens in the plurality of groups of data tokens, the group of data tokens includes a larger number of tokens than the corresponding set of latent tokens.

Embodiment 5 is the method of embodiment 4, wherein a number of tokens in the group of data tokens is dependent on a size of the network input and a number of tokens in the set of latent tokens is fixed and independent of the size of the network input.

Embodiment 6 is the method of any of embodiments 1-5, wherein:
the sequence of time steps includes a plurality of time steps.

Embodiment 7 is the method of any of embodiments 1-6, wherein initializing a plurality of sets of latent tokens for the time step comprises, for each set of latent tokens:
initializing at least a subset of the latent tokens to be equal to a set of learned latent embedding vectors.

Embodiment 8 is the method of embodiment 7, wherein the learned latent embeddings are learned during training of the neural network blocks in the sequence.

Embodiment 9 is the method of any of embodiments 1-8, further comprising:
receiving a conditioning input; and
generating, from the conditioning input, one or more conditioning embedding vectors, wherein the network output is conditioned on the conditioning embedding vectors.

Embodiment 10 is the method of embodiment 9, wherein:
initializing a plurality of sets of latent tokens for the time step comprises including the one or more conditioning embedding vectors in each set of latent tokens.

Embodiment 11 is the method of any of embodiments 9-10, wherein generating a plurality of groups of data tokens for the time step comprises including the one or more conditioning embedding vectors in each group of data tokens.

Embodiment 12 is the method of any of embodiments 1-11, further comprising:
generating, from an identifier for the time step, one or more time step embedding vectors,
wherein the network output is conditioned on the time step embedding vectors.

Embodiment 13 is the method of embodiment 12, wherein:
initializing a plurality of sets of latent tokens for the time step comprises including the one or more time step embedding vectors in each set of latent tokens.

Embodiment 14 is the method of any of embodiments 12-13, wherein generating a plurality of groups of data tokens for the time step comprises including the one or more time step embedding vectors in each group of data tokens.

Embodiment 15 is the method of any of embodiments 4-14, wherein:
at the first iteration of the plurality of iterations, the network input comprises a noisy version of a target output;
the network input for each time step is a current version of the target output as of the time step;
the network output for the time step defines an estimate of the target output given the current version of the target output as of the time step; and
the method further comprises, at each time step:
   updating the current version of the target output using the network output for the time step.

Embodiment 16 is the method of embodiment 15, further comprising:
at a final time step of the plurality of time steps and after updating the current version of the target output using the network output for the final time step, providing, as a final estimate of the target output, the updated current version of the target output.

Embodiment 17 is the method of any of embodiments 15-16, wherein the network output is an estimate of noise added to the target output to generate the current version of the target output as of the time step.

Embodiment 18 is the method of any of embodiments 15-16, the network output is the estimate of the target output to generate the current version of the target output as of the time step.

Embodiment 19 is the method of any of embodiments 15-18, wherein updating the current version of the target output using the network output for the time step comprises applying a diffusion model state transition rule to at least the current version of the target output as of the time step and the network output for the time step.

Embodiment 20 is the method of any of embodiments 1-19, wherein initializing the plurality of sets of latent tokens comprises initializing the latent tokens independently from the network input for the time step.

Embodiment 21 is the method of any of embodiments 1-20, wherein the second neural network is configured to apply attention over the latent tokens in the corresponding set and the data tokens of the group with queries derived from the latent tokens and keys and values derived from the data tokens.

Embodiment 22 is the method of any of embodiments 1-21, wherein the fourth neural network is configured to apply attention over the latent tokens in the corresponding set and the data tokens of the group with keys and values derived from the latent tokens and queries derived from the data tokens.

Embodiment 23 is the method of any of embodiments 1-22, wherein the third neural network is configured to apply attention over the plurality of sets of latent tokens with keys and queries and values derived from the plurality of sets of latent tokens.

Embodiment 24 is the method of any of embodiments 1-23, wherein the first neural network is configured to apply attention over the data tokens of the group with keys and queries and values derived from the data tokens.

Embodiment 25 is the method of any of embodiments 21-24, wherein the attention is multi-head attention.

Embodiment 26 is the method of any of embodiments 1-25, wherein the method further comprises generating the network input from an original network input for the time step, and the original network input comprises a collection of data elements.

Embodiment 27 is the method of embodiment 26, wherein generating, from at least the original network input for the time step, the network input comprises:
generating a respective data token from each of a plurality of subgroups of the collection of data elements.

Embodiment 28 is the method of embodiment 27, wherein generating a respective data token from each of a plurality of subgroups of the collection of data elements comprises, for each of the plurality of subgroups:
applying one or more learned projection layers to the data elements in the subgroup to generate the respective data token for the subgroup.

Embodiment 29 is the method of embodiment 26, wherein generating, from at least the network input for the time step, a plurality of groups of data tokens comprises:
grouping the respective data tokens into a plurality of groups of data tokens.

Embodiment 30 is the method of embodiment 27, wherein each data token comprises an embedding of each subgroup of data elements.

Embodiment 31 is the method of embodiment 30, wherein each data token further comprises a positional encoding.

Embodiment 32 is the method of any of embodiments 1-31, wherein, at each time step, the network input comprises one or more fixed data elements and a plurality of unfixed data elements, and wherein the network output at the time step defines an estimate of a completion of the unfixed data elements given at least the fixed data elements.

Embodiment 33 is a method comprising, at each time step in a sequence of one or more time steps:
obtaining a network input for the time step, wherein the network input comprises a plurality of data tokens;
generating, from at least the network input for the time step, a plurality of groups of data tokens;
initializing a plurality of sets of latent tokens for the time step, each set corresponding to a respective one of the plurality of groups;
processing the data tokens in each group and the plurality of sets of latent tokens through each neural network block in a sequence of neural network blocks to update the plurality of groups of data tokens and the plurality of sets of latent tokens, wherein each neural network block in the sequence is configured to perform operations comprising:
   for each group of data tokens, processing the data tokens in the group using a first neural network to update the data tokens in the group;
   after processing the data tokens in the group using the first neural network to update the data tokens in the group, for each group other than the first group of data tokens, processing the data tokens in an immediately preceding group and the latent tokens in the corresponding set using a second neural network to update the latent tokens in the corresponding set;
after processing, for each group other than the first group of data tokens, the data tokens in an immediately preceding group and the latent tokens in the corresponding set using the second neural network to update the latent tokens in the corresponding set, processing the plurality of sets of latent tokens using a third neural network to update the latent tokens; after processing each group of data tokens and the latent tokens through the sequence of neural network blocks to update the plurality of groups of data tokens and the plurality of sets of latent tokens, generating a network output for the time step from the data tokens, the latent tokens, or both.

Embodiment 34 is the method of embodiment 33, wherein each neural network block in the sequence after a first neural network block in the sequence is further configured to perform operations comprising:
prior to processing, for each group of data tokens, the data tokens in the group using the first neural network to update the data tokens in the group, for each group of data tokens, processing the data tokens in the group and the latent tokens in the corresponding set using a fourth neural network to update the data tokens in the group.

Embodiment 35 is the method of any of embodiment 33-34, wherein generating a network output for the time step from the data tokens, the latent tokens, or both comprises using a readout neural network to generate a network output for the time step.

Embodiment 36 is the method of any of embodiments 33-35, wherein the first neural network is configured to apply causal masked attention, and the third neural network is configured to apply causal masked attention.

Embodiment 37 is the method of any of embodiments 33-36, wherein for each group of data tokens in the plurality of groups of data tokens, the group of data tokens includes a larger number of tokens than the corresponding set of latent tokens.

Embodiment 38 is the method of embodiment 37, wherein a number of tokens in the group of data tokens is dependent on a size of the network input and a number of tokens in the set of latent tokens is fixed and independent of the size of the network input.

Embodiment 39 is the method of any of embodiments 33-38, wherein:
the sequence of time steps includes a plurality of time steps.

Embodiment 40 is the method of any of embodiments 33-39, wherein initializing a plurality of sets of latent tokens for the time step comprises, for each set of latent tokens:
initializing at least a subset of the latent tokens to be equal to a set of learned latent embedding vectors.

Embodiment 41 is the method of embodiment 40, wherein the learned latent embeddings are learned during training of the neural network blocks in the sequence.

Embodiment 42 is the method of any of embodiments 33-41, further comprising:
receiving a conditioning input; and
generating, from the conditioning input, one or more conditioning embedding vectors, wherein the network output is conditioned on the conditioning embedding vectors.

Embodiment 43 is the method of embodiment 42, wherein:
initializing a plurality of sets of latent tokens for the time step comprises including the one or more conditioning embedding vectors in each set of latent tokens.

Embodiment 44 is the method of any of embodiments 42-43, wherein generating a plurality of groups of data tokens for the time step comprises including the one or more conditioning embedding vectors in each group of data tokens.

Embodiment 45 is the method of any of embodiments 33-44, further comprising:
generating, from an identifier for the time step, one or more time step embedding vectors,
wherein the network output is conditioned on the time step embedding vectors.

Embodiment 46 is the method of embodiment 45, wherein:
initializing a plurality of sets of latent tokens for the time step comprises including the one or more time step embedding vectors in each set of latent tokens.

Embodiment 47 is the method of any of embodiments 45-46, wherein generating a plurality of groups of data tokens for the time step comprises including the one or more time step embedding vectors in each group of data tokens.

Embodiment 48 is the method of any of embodiments 33-47, wherein initializing the plurality of sets of latent tokens comprises initializing the latent tokens independently from the network input for the time step.

Embodiment 49 is the method of any of embodiments 33-48, wherein the second neural network is configured to apply attention over the latent tokens in the corresponding set and the data tokens of the group with queries derived from the latent tokens and keys and values derived from the data tokens.

Embodiment 50 is the method of any of embodiments 33-49, wherein the fourth neural network is configured to apply attention over the latent tokens in the corresponding set and the data tokens of the group with keys and values derived from the latent tokens and queries derived from the data tokens.

Embodiment 51 is the method of any of embodiments 33-50, wherein the third neural network is configured to apply attention over the plurality of sets of latent tokens with keys and queries and values derived from the plurality of sets of latent tokens.

Embodiment 52 is the method of any of embodiments 33-51, wherein the first neural network is configured to apply attention over the data tokens of the group with keys and queries and values derived from the data tokens.

Embodiment 53 is the method of any of embodiments 49-52, wherein the attention is multi-head attention.

Embodiment 54 is the method of any of embodiments 33-53, wherein the method further comprises generating the network input from an original network input for the time step, and the original network input comprises a collection of data elements.

Embodiment 55 is the method of embodiment 54, wherein generating, from at least the original network input for the time step, the network input comprises:
generating a respective data token from each of a plurality of subgroups of the collection of data elements.

Embodiment 56 is the method of embodiment 55, wherein generating a respective data token from each of a plurality of subgroups of the collection of data elements comprises, for each of the plurality of subgroups:
applying one or more learned projection layers to the data elements in the subgroup to generate the respective data token for the subgroup.

Embodiment 57 is the method of embodiment 54, wherein generating, from at least the network input for the time step, a plurality of groups of data tokens comprises:
grouping the respective data tokens into a plurality of groups of data tokens.

Embodiment 58 is the method of embodiment 55, wherein each data token comprises an embedding of each subgroup of data elements.

Embodiment 59 is the method of embodiment 58, wherein each data token further comprises a positional encoding.

Embodiment 60 is a system comprising:
one or more computers; and
one or more storage devices communicatively coupled to the one or more computers, wherein the one or more storage devices store instructions that, when executed by the one or more computers, cause the one or more computers to perform the method of any of embodiments 1-59.

Embodiment 61 is one or more non-transitory computer storage media storing instructions that when executed by one or more computers cause the one or more computers to perform operations of the method of any of embodiments 1-59.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising, at each time step in a sequence of one or more time steps:
obtaining a network input for the time step, wherein the network input comprises a plurality of data tokens;
generating, from at least the network input for the time step, a plurality of groups of data tokens;
initializing a plurality of sets of latent tokens for the time step, each set corresponding to a respective one of the plurality of groups;
processing the data tokens in each group and the plurality of sets of latent tokens through each neural network block in a sequence of neural network blocks to update the plurality of groups of data tokens and the plurality of sets of latent tokens, wherein each neural network block in the sequence is configured to perform operations comprising:
for each group of data tokens, processing the data tokens in the group using a first neural network to update the data tokens in the group;
for each group of data tokens, processing the data tokens in the group and the latent tokens in the corresponding set using a second neural network to update the latent tokens in the corresponding set;
processing the plurality of sets of latent tokens using a third neural network to update the latent tokens;
generating a network output for the time step from the data tokens, the latent tokens, or both.

2. The method of claim 1, wherein each neural network block in the sequence after a first neural network block in the sequence is further configured to perform operations comprising:
prior to processing, for each group of data tokens, the data tokens in the group using the first neural network to update the data tokens in the group, for each group of data tokens, processing the data tokens in the group and the latent tokens in the corresponding set using a fourth neural network to update the data tokens in the group.

3. The method of claim 1, wherein generating a network output for the time step from the data tokens, the latent tokens, or both comprises using a readout neural network to generate a network output for the time step.

4. The method of claim 1, wherein for each group of data tokens in the plurality of groups of data tokens, the group of data tokens includes a larger number of tokens than the corresponding set of latent tokens.

5. The method of claim 4, wherein a number of tokens in the group of data tokens is dependent on a size of the network input and a number of tokens in the set of latent tokens is fixed and independent of the size of the network input.

6. The method of claim 1, wherein initializing a plurality of sets of latent tokens for the time step comprises, for each set of latent tokens:
initializing at least a subset of the latent tokens to be equal to a set of learned latent embedding vectors.

7. The method of claim 4, wherein:
at the first iteration of the plurality of iterations, the network input comprises a noisy version of a target output;
the network input for each time step is a current version of the target output as of the time step;
the network output for the time step defines an estimate of the target output given the current version of the target output as of the time step; and
the method further comprises, at each time step:
updating the current version of the target output using the network output for the time step.

8. The method of claim 7, further comprising:
at a final time step of the plurality of time steps and after updating the current version of the target output using the network output for the final time step, providing, as a final estimate of the target output, the updated current version of the target output.

9. The method of claim 1, wherein the second neural network is configured to apply attention over the latent tokens in the corresponding set and the data tokens of the group with queries derived from the latent tokens and keys and values derived from the data tokens.

10. The method of claim 1, wherein the fourth neural network is configured to apply attention over the latent tokens in the corresponding set and the data tokens of the group with keys and values derived from the latent tokens and queries derived from the data tokens.

11. The method of claim 1, wherein the third neural network is configured to apply attention over the plurality of sets of latent tokens with keys and queries and values derived from the plurality of sets of latent tokens.

12. The method of claim 1, wherein the first neural network is configured to apply attention over the data tokens of the group with keys and queries and values derived from the data tokens.

13. The method of claim 1, wherein the method further comprises generating the network input from an original network input for the time step, and the original network input comprises a collection of data elements.

14. The method of claim 13, wherein generating, from at least the original network input for the time step, the network input comprises:
generating a respective data token from each of a plurality of subgroups of the collection of data elements.

15. The method of claim 14, wherein generating a respective data token from each of a plurality of subgroups of the collection of data elements comprises, for each of the plurality of subgroups:
applying one or more learned projection layers to the data elements in the subgroup to generate the respective data token for the subgroup.

16. The method of claim 13, wherein generating, from at least the network input for the time step, a plurality of groups of data tokens comprises:
grouping the respective data tokens into a plurality of groups of data tokens.

17. The method of claim 14, wherein each data token comprises an embedding of each subgroup of data elements.

18. The method of claim 17, wherein each data token further comprises a positional encoding.

19. A system comprising:
one or more computers; and
one or more storage devices communicatively coupled to the one or more computers, wherein the one or more storage devices store instructions that, when executed by the one or more computers, cause the one or more computers to perform operations comprising, at each time step in a sequence of one or more time steps:
obtaining a network input for the time step, wherein the network input comprises a plurality of data tokens;
generating, from at least the network input for the time step, a plurality of groups of data tokens;
initializing a plurality of sets of latent tokens for the time step, each set corresponding to a respective one of the plurality of groups;
processing the data tokens in each group and the plurality of sets of latent tokens through each neural network block in a sequence of neural network blocks to update the plurality of groups of data tokens and the plurality of sets of latent tokens, wherein each neural network block in the sequence is configured to perform operations comprising:
for each group of data tokens, processing the data tokens in the group using a first neural network to update the data tokens in the group;
for each group of data tokens, processing the data tokens in the group and the latent tokens in the corresponding set using a second neural network to update the latent tokens in the corresponding set;
processing the plurality of sets of latent tokens using a third neural network to update the latent tokens;
generating a network output for the time step from the data tokens, the latent tokens, or both.

20. One or more non-transitory computer storage media storing instructions that when executed by one or more computers cause the one or more computers to perform operations comprising, at each time step in a sequence of one or more time steps:
obtaining a network input for the time step, wherein the network input comprises a plurality of data tokens;
generating, from at least the network input for the time step, a plurality of groups of data tokens;
initializing a plurality of sets of latent tokens for the time step, each set corresponding to a respective one of the plurality of groups;
processing the data tokens in each group and the plurality of sets of latent tokens through each neural network block in a sequence of neural network blocks to update the plurality of groups of data tokens and the plurality of sets of latent tokens, wherein each neural network block in the sequence is configured to perform operations comprising:
for each group of data tokens, processing the data tokens in the group using a first neural network to update the data tokens in the group;
processing the data tokens in the group and the latent tokens in the corresponding set using a second neural network to update the latent tokens in the corresponding set;
processing the plurality of sets of latent tokens using a third neural network to update the latent tokens;
generating a network output for the time step from the data tokens, the latent tokens, or both.
